(19) United States
(12) Patent Application Publication
(10) Pub. No.: US 2026/0024158 A1
(43) Pub. Date: Jan. 22, 2026

(54) STORE MONITORING DEVICE, POINT-OF-SALE SYSTEM, AND STORAGE MEDIUM

(71) Applicant: Toshiba Tec Kabushiki Kaisha, Tokyo (JP)

(72) Inventor: Takumi TAKAHASHI, Mishima Shizuoka (JP)

(21) Appl. No.: 19/193,884

(22) Filed: Apr. 29, 2025

(30) Foreign Application Priority Data
Jul. 18, 2024 (JP) 2024-114719

(51) Int. Cl. G06Q 90/00; G06Q 20/20; G06V 20/52; G06V 40/10

(52) U.S. Cl. CPC G06Q 90/20; G06Q 20/20; G06V 20/53; G06V 40/10

(57) ABSTRACT

A store monitoring device includes a memory that stores first information indicating self-service and staffed checkout devices, and a processor configured to: acquire from cameras first images of customers and containers or carts used thereby, second images of a checkout waiting area, identify a first customer and first items to be purchased thereby, determine whether the first customer is in the checkout waiting area, upon determining that the first customer is in the waiting area, determine whether a line is formed in the checkout waiting area, upon determining that a line is formed, determine a first quantity of the first items, when the first quantity is greater than or equal to a threshold, output first information for guiding the first customer to a staffed checkout device, and when the first quantity is less than the threshold, output second information for guiding the customer to a self-service checkout device.

### CROSS-REFERENCE TO RELATED APPLICATION

This application is based upon and claims the benefit of priority from Japanese Patent Application No. 2024-114719, filed Jul. 18, 2024, the entire contents of which are incorporated herein by reference.

### FIELD

Embodiments described herein relate generally to a store monitoring device, a point-of-sale (POS) system, and a storage medium.

### BACKGROUND

At a retail store such as a supermarket, a self-service checkout device with which a customer himself or herself can perform registration or checkout of a merchandise item is introduced in addition to a checkout device such as a POS terminal with which store staff performs registration or checkout for a customer (hereinafter referred to as staffed checkout device). For example, a customer can perform registration and checkout of a merchandise item, using a POS terminal provided on a shopping cart, a semi-self-service checkout device, a full-self-service checkout device, or the like. Thus, convenience can be improved for both the store and the customer.

Meanwhile, the occurrence of checkout waiting lines is still not uncommon when the checkout area is crowded or the like, which makes the customer feel stressed. Also, at a store where a semi-self-service checkout device and a full-self-service checkout device are installed in addition to a staffed checkout device, the customer may wonder which checkout device to use.

### BRIEF DESCRIPTION OF THE DRAWINGS

FIG. 1 schematically shows a purchase support system according to an embodiment.

FIG. 2 shows a configuration of a purchase support device.

FIG. 3 shows a data structure of a merchandise master.

FIG. 4 shows a data structure of a stored merchandise management table.

FIG. 5 shows a data structure of a checkout device management table.

FIG. 6 shows a data structure of a store staff management table.

FIG. 7 is a flowchart of purchase support processing.

### DETAILED DESCRIPTION

Embodiments of this disclosure provide a store monitoring device, a POS system, and a storage medium that can notify a customer of a suitable type of checkout device.

In general, according to one embodiment, a store monitoring device comprises a communication interface connectable to one or more cameras installed in a store; a memory that stores a program and first information indicating a plurality of checkout devices installed in the store, the checkout devices including one or more self-service checkout devices and one or more staffed checkout devices; and a processor configured to execute the program to: acquire a plurality of images from the cameras and identify from the images: one or more first images of customers and containers or carts used by the customers, and one or more second images of a checkout waiting area in which customers can form a line for checkout, identify a first customer and one or more first items to be purchased by the first customer based on the first images, determine whether the first customer is in the checkout waiting area based on the second images, upon determining that the first customer is in the checkout waiting area, determine whether a line is formed in the checkout waiting area based on the second images, upon determining that a line is formed, determine a first quantity of the first items, when the first quantity is greater than or equal to a threshold, generate and output first guidance information for guiding the first customer to one of the staffed checkout devices, and when the first quantity is less than the threshold, generate and output second guidance information for guiding the first customer to one of the self-service checkout devices.

A store monitoring device, a POS system, and a storage medium according to embodiments will now be described with reference to the drawings. The elements in the embodiments described below include elements which a person skilled in the art can readily think of, substantially the same elements, and elements in a range of so-called equivalents. Also, various omissions, substitutions, changes, and combinations of the elements can be made without departing from the scope of the embodiments described below. In the embodiments described below, an example in which the purchase support device, the purchase support system, and the purchase support method are applied to a store such as a supermarket will be described. However, the embodiments are not limited to this example.

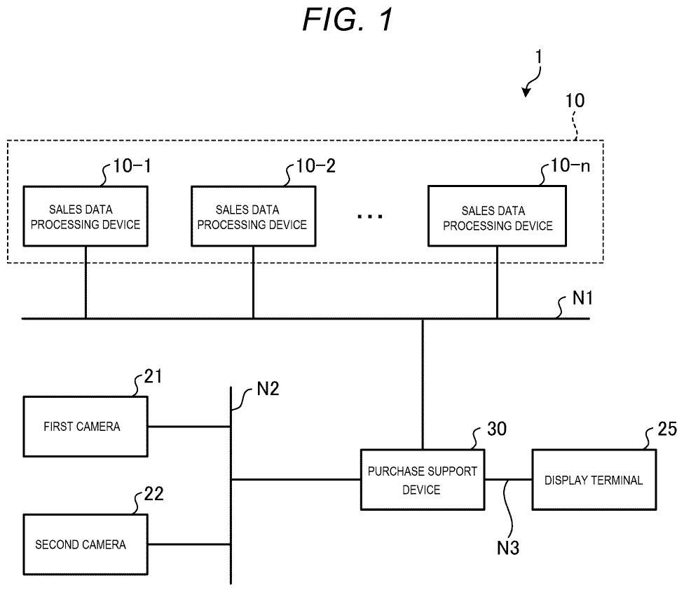

FIG. 1 schematically shows a purchase support system 1 according to an embodiment. The purchase support system 1 is a POS system that includes a plurality of different types of sales data processing devices 10, a first camera 21, a second camera 22, a display terminal 25, and a purchase support device 30. The sales data processing devices 10 are a plurality of different types of POS checkout devices installed in the store and may be referred to as checkout terminals. Each of the plurality of different types of sales data processing devices 10 performs registration and checkout of merchandise items in one transaction with a customer, referring to, a merchandise master, described later, which stores the merchandise code and unit price or the like of each merchandise item available for sale in the store.

The different types of the sales data processing devices 10 are, for example, a type of a full-self-service checkout device, a type of a semi-self-service checkout device, a type of a staffed checkout device (hereinafter also referred to as a store staff checkout device), and the like. These types may also be referred to as a full-self-service type, a semi-self-service type, and a staffed type. The store staff checkout device corresponds to, for example, a sales data processing device with which store staff registers a merchandise item of a customer and processes the checkout of the registered merchandise item. That is, the store staff checkout device is equivalent to a store staff POS terminal having the functions of a registration device and a checkout device.

The semi-self-service checkout device is implemented, for example, by a combination of a registration device for store staff and a checkout device with which a customer himself or herself performs checkout. The full-self-service checkout device is implemented, for example, by a customer POS terminal with which a customer performs both registration and checkout. The full-self-service checkout device is installed in a store. However, the full-self-service checkout device is not limited to the device installed in the store and may be implemented, for example, by a combination of a terminal device for merchandise registration that is movable with a customer (hereinafter also referred to as a user terminal) and a checkout device with which the customer himself or herself performs the checkout. In this case, the user terminal is, for example, a terminal device such as a smartphone which the customer possesses, a mobile terminal which the store loans to the customer, or a tablet terminal installed on a shopping cart, and the checkout device corresponds to the sales data processing device 10. The plurality of different types of sales data processing devices 10 are connected to the purchase support device 30 via a wired or wireless network N1.

The first camera 21 captures an image of a predetermined area in the store where the plurality of different types of sales data processing devices 10 are placed. The predetermined area is, for example, an area where customers waiting for checkout with the plurality of different types of sales data processing devices 10 can type lines. Hereinafter, a line of customers waiting for checkout is referred to as a “waiting line” and the area where the waiting line is formed is referred to as a “checkout waiting area”. That is, the predetermined area may be referred to as the checkout waiting area. The first camera 21 is provided at a position where the first camera 21 can capture an image of the checkout waiting area. For example, the first camera 21 is provided at the ceiling directly above the checkout waiting area.

A plurality of first cameras 21 may be provided, for example, in response to the number of the plurality of different types of sales data processing devices 10 and the positions of installation thereof, or the like. The first camera 21 is not limited to an optical camera and may be any imaging device, provided that the first camera 21 can capture an image of the checkout waiting area. The first camera 21 is connected to the purchase support device 30 via a wired or wireless network N2. The first camera 21 transmits image data generated by capturing an image of the checkout waiting area (hereinafter referred to as area image data) to the purchase support device 30 via the network N2.

The second camera 22 is equivalent to, for example, a monitoring camera. The second camera 22 captures an image of a shopping basket and/or a shopping cart held or used by a customer moving inside the store. A plurality of second cameras 22 are installed at any positions inside the store. Preferably, the second camera 22 may be able to capture an image of the entire area inside the store (though the checkout waiting area may be excluded). The second camera 22 is not limited to an optical camera and may be any imaging device, provided that the second camera 22 can capture an image of the shopping basket and/or the shopping cart.

The second camera 22 is connected to the purchase support device 30 via the network N2. The second camera 22 transmits image data generated by capturing an image of the shopping basket and/or the shopping cart (hereinafter referred to as merchandise image data) to the purchase support device 30 via the network N2.

The display terminal 25 displays the type of the checkout device determined by the purchase support device 30 (hereinafter referred to as a recommended checkout device). The display terminal 25 is connected to the purchase support device 30 via a wired or wireless network N3. The display terminal 25 is implemented, for example, by the user terminal installed on a shopping cart, or a display or monitor provided in the predetermined area (i.e., the checkout waiting area).

The display terminal 25 is not limited to the above-described display or monitor and may be implemented, for example, by a projection machine or a projector or the like that displays the recommended checkout device in the predetermined area or the like. The display terminal 25 may also be referred to as a display unit, a display device, or the like. The networks N1, N2, and N3 may be the same network.

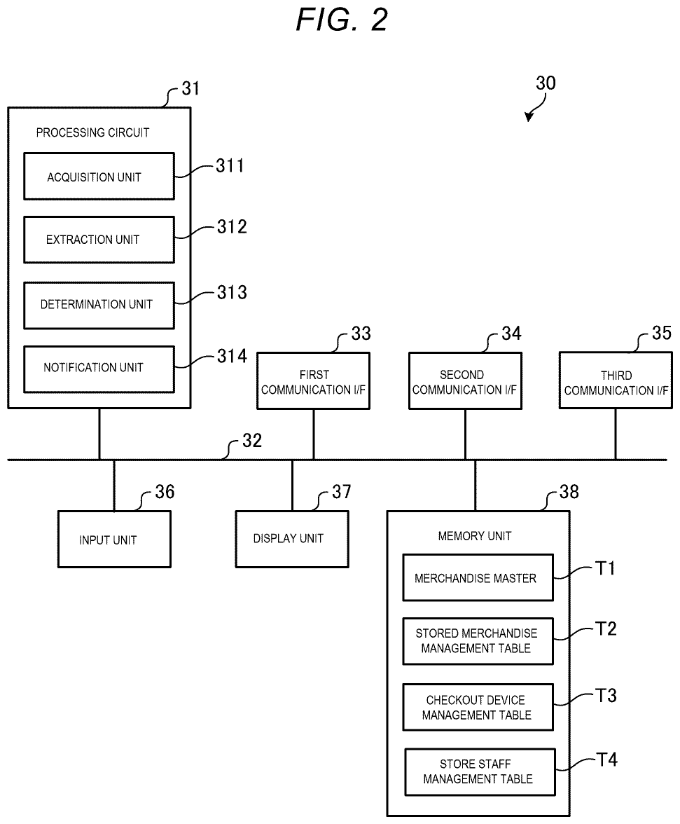

The purchase support device 30 is a store monitoring device that executes various processing implemented according to this embodiment. The purchase support device 30 can be implemented, for example, by various server devices. FIG. 2 shows a configuration of the purchase support device 30. As shown in FIG. 2, the purchase support device 30 includes a processing circuit 31 having a central processing unit (CPU), a read only memory (ROM), a random access memory (RAM), and the like. The processing circuit 31 also includes a time tracking function such as real-time clock (RTC).

A first communication interface (I/F) 33, a second communication I/F 34, a third communication I/F 35, an input unit 36, a display unit 37, and a memory unit 38 are coupled to the processing circuit 31 via a bus 32.

The first communication I/F 33 is a wired or wireless communication I/F circuit for connecting to the network N1. The second communication I/F 34 is a wired or wireless communication I/F circuit for connecting to network N2. The third communication I/F 35 is a wired or wireless communication I/F for connecting to the network N3.

The input unit 36 includes an input device such as a keyboard. The input unit 36 accepts an operation input from an operator via the input device. The input unit 36 notifies the processing circuit 31 of a signal corresponding to the content of the operation on the input device. The display unit 37 includes a display device such as a liquid crystal display. The display unit 37 displays various information under the control of the processing circuit 31.

The memory unit 38 includes a memory device such as a hard disk drive (HDD) or a solid state drive (SSD). The memory unit 38 stores various programs executed by the processing circuit 31 (i.e., CPU) and various setting information. The memory unit 38 also stores, for example, a merchandise master T1, a stored merchandise management table T2, a checkout device management table T3, and a store staff management table T4.

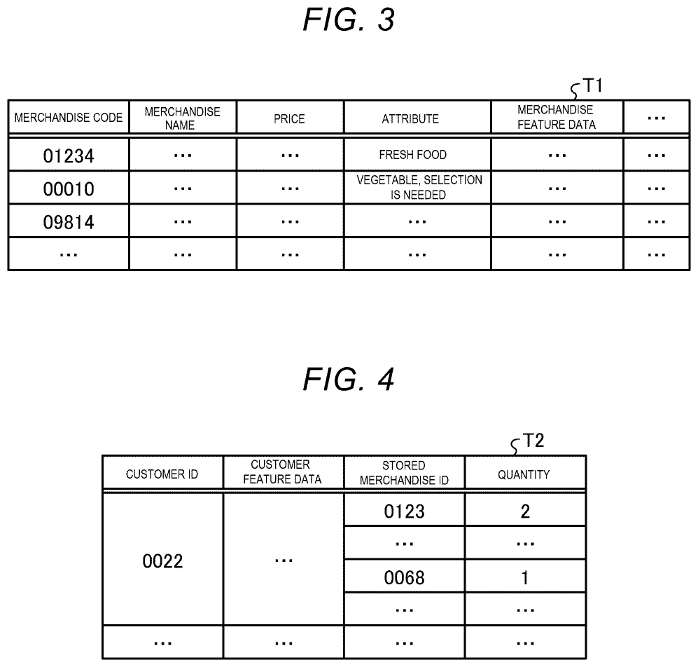

FIG. 3 shows a data structure of the merchandise master T1. The merchandise master T1 is, for example, a database in which information about merchandise items available and sold at the store where the purchase support system 1 is installed is put together. As shown in FIG. 3, the fields in the merchandise master T1 include, for example, “merchandise code” also referred to as “merchandise ID”, “merchandise name”, “price”, “attribute”, “merchandise feature data”, and the like.

The attribute, of the fields in the merchandise master T1, includes, for example, the type of merchandise such as fresh food, frozen food, vegetables, or alcohol, the size or weight of merchandise categorized by a predetermined indicator (for example, small size, medium size, large size, and the like), and information indicating that at least one field included in the attribute needs to be selected at the checkout device at the time of checkout (hereinafter referred to as selection need information). For example, a type such as a vegetable delivered directly from the farm corresponds to the attribute of vegetable of fresh food and the user needs to select, for example, at least one of the name, size, and weight of this vegetable delivered directly from the farm at the checkout device at the time of checkout. Therefore, information indicating that selection is needed is registered as the selection need information in the field of attribute in the merchandise master T1.

The merchandise feature data, of the fields in the merchandise master T1, corresponds to, for example, a feature vector acquired by image recognition processing on an image showing the external appearance of the merchandise item (for example, semantic segmentation or the like based on a learning model such as semantic CNN). The feature vector is, for example, an output inputted to an output layer of the learning model for recognizing the merchandise item, and is an output from an intermediate layer in the final tier, or the like. The merchandise feature data is not limited to the feature vector and may be an output from various kinds of known image processing. The fields in the merchandise master T1 are not limited to those shown in FIG. 3 and may include other fields such as supplier.

FIG. 4 shows a data structure of the stored merchandise management table T2. The stored merchandise management table T2 is a table for managing merchandise items stored in the shopping basket and/or the shopping cart held or used by a customer moving inside the store. As shown in FIG. 4, the fields in the stored merchandise management table T2 include, for example, “customer ID”, “customer feature data” representing a feature of the customer, “stored merchandise ID”, and “quantity”. The customer ID is an identifier for identifying the customer. The customer ID is generated by the processing circuit 31 and added to the stored merchandise management table T2, for example, when the entry of the customer into the store is detected by the first camera 21 or the second camera 22, or the like.

The field of customer feature data in the stored merchandise management table T2 corresponds to, for example, a feature vector acquired by the above-described image recognition processing on an image of the customer. The customer feature data is not limited to the feature vector and may be an output from various kinds of known image processing. The field of stored merchandise ID in the stored merchandise management table T2 is a field indicating the merchandise ID of the merchandise item stored in the shopping basket and/or the shopping cart held or used by the customer. The field of quantity in the stored merchandise management table T2 is a field indicating the number of merchandise items corresponding to the merchandise ID stored in the shopping basket and/or the shopping cart held or used by the customer. When the exit of the customer from the store is detected by the first camera 21 or the second camera 22, or the like, the various fields related to the customer ID corresponding to the exiting customer are deleted from the stored merchandise management table T2 by the processing circuit 31.

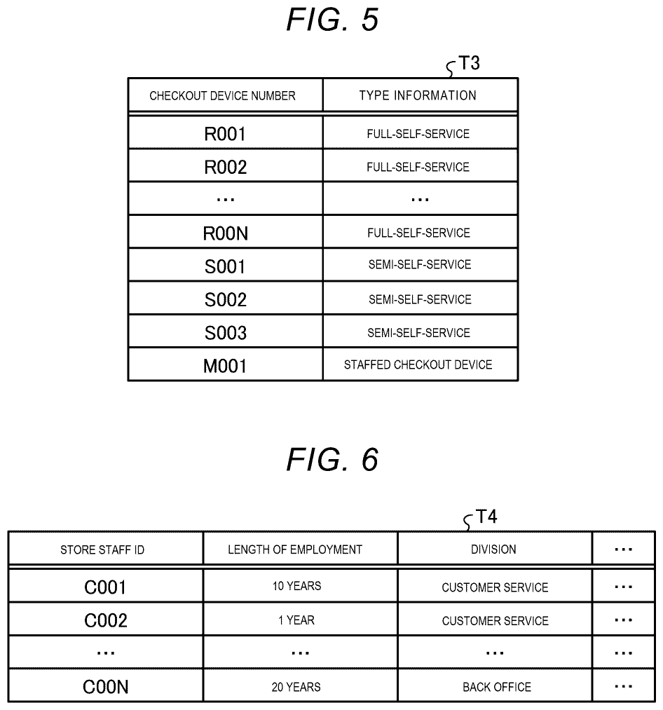

FIG. 5 shows a data structure of the checkout device management table T3. The checkout device management table T3 is a table for managing the plurality of different types of sales data processing devices (or checkout devices) 10. The fields in the checkout device management table T3 include checkout device numbers for specifying the plurality of checkout devices, and type information indicating the forms of the checkout devices.

The type information is information indicating the type of the checkout device. As shown in FIG. 5, one of the types of full-self-service, semi-self-service, and staffed checkout device is allocated to each checkout device. In the correspondence between FIG. 1 and FIG. 5, for example, a sales data processing device 10-1 corresponds to a checkout device number R001, a sales data processing device 10-2 corresponds to a checkout device number R002, and a sales data processing device 10-n corresponds to a checkout device number M001.

FIG. 6 shows a data structure of the store staff management table T4. As shown in FIG. 6, the store staff management table T4 stores a store staff ID identifying each store staff member, in correlation with the length of employment and division or the like of the store staff member. The store staff management table T4 is timely updated in response to the employment, retirement, years of service or the like of the store staff.

The memory unit 38 also stores a predetermined threshold to be compared with the quantity of the merchandise item stored in the shopping basket and/or the shopping cart. The predetermined threshold is set in advance but may be suitably changed in response to an instruction from the user such as the store staff via the input unit 36. The memory unit 38 stores a set value to be compared with the quantity of a merchandise item for which a field included in the attribute needs to be selected at the time of checkout (correlated with the selection need information) (hereinafter referred to as a merchandise item involving complexity at the checkout), of the merchandise items stored in the shopping basket and/or the shopping cart. The set value is set in advance but may be suitably changed in response to an instruction from the user such as the store staff via the input unit 36.

The purchase support device 30 executes various processing by the collaboration between the processing circuit 31 and a program stored in the ROM or the memory unit 38. Specifically, the processing circuit 31 executes the program and thus performs functions of an acquisition unit 311, an extraction unit 312, a determination unit 313, and a notification unit 314 or the like, as shown in FIG. 2. The acquisition unit 311, the extraction unit 312, the determination unit 313, and the notification unit 314 may be performed by dedicated circuits.

The acquisition unit 311 acquires image data from the first camera 21 or the second camera 22 in response to the entry of a customer into the store. For example, the acquisition unit 311 acquires, from the second camera 22, merchandise image data formed by capturing an image of the shopping basket and/or the shopping cart held or used by the customer moving inside the store. Also, for example, the acquisition unit 311 acquires area image data from the first camera 21. The acquisition unit 311 stores the merchandise image data and the area image data that are acquired, in the memory unit 38.

The extraction unit 312 extracts customer feature data from the merchandise image data or the area image data. For example, the extraction unit 312 inputs the merchandise image data or the area image data to a learning model that can recognize the image of the customer, and extracts the customer feature data from the learning model. If the extracted customer feature data is not stored in the stored merchandise management table T2, the extraction unit 312 issues a customer ID and stores the extracted customer feature data in correlation with the issued customer ID, in the stored merchandise management table T2.

The extraction unit 312 extracts the customer feature data in time series from the merchandise image data or the area image data acquired in time series in response to the movement of the customer. At this time, the extraction unit 312 collates the extracted customer feature data with the customer feature data stored in the stored merchandise management table T2 and thus specifies the customer ID of the same customer in the store, in the stored merchandise management table T2.

The extraction unit 312 determines, from the merchandise image data, a factor related to the checkout time for the merchandise item stored in the shopping basket and/or the shopping cart held by the customer. For example, the extraction unit 312 inputs the merchandise image data to a learning model that can recognize the image of the merchandise item, and extracts the merchandise feature data from the learning model. The extraction unit 312 collates the extracted merchandise feature data with the merchandise feature data in the merchandise master T1, and specifies the merchandise ID corresponding to the extracted merchandise feature data. The extraction unit 312 registers the merchandise ID and the quantity in correlation with the specified customer ID, in the stored merchandise management table T2. As will be described later, the factor related to the checkout time is an element for determining the type of checkout device recommended as the checkout spot for the merchandise item desired by the customer.

Subsequently, the extraction unit 312 extracts the attribute of the merchandise item corresponding to the specified merchandise ID from the merchandise master T1, using the specified merchandise ID. The extraction unit 312 also extracts the quantity of the merchandise item corresponding to the specified ID from the stored merchandise management table T2, using the specified merchandise ID. The quantity of the merchandise item and the attribute of the merchandise item are correlated with the length of the checkout time.

The extraction unit 312 also extracts, from the merchandise image data, the quantity of the merchandise item correlated with the selection need information, of the merchandise items stored in the shopping basket and/or the shopping cart. For example, the extraction unit 312 collates the merchandise feature data extracted from the merchandise image data with the merchandise master T1 and thus determines whether the attribute includes the selection need information.

The extraction unit 312 also extracts, from the area image data, the number of people waiting for the processing with the sales data processing device 10 (hereinafter referred to as the number of people waiting for checkout) as a waiting line. That is, the extraction unit 312 extracts the number of people waiting for checkout as a factor related to the checkout time, from the area image data. The extraction unit 312 stores the extracted factor related to the checkout time in correlation with the customer ID, in the memory unit 38.

Thus, the quantity of the merchandise item, the attribute of the merchandise item, and the waiting line are included in the factor related to the checkout time for the merchandise item. Therefore, the extraction unit 312 extracts the merchandise data including the quantity of the merchandise item and the attribute of the merchandise item stored in the shopping basket and/or the shopping cart as the factor related to the checkout time from the merchandise image data.

The determination unit 313 determines whether the customer is located in the predetermined area, based on the area image data. For example, the determination unit 313 determines whether the customer feature data extracted from the area image data is included in the stored merchandise management table T2, and thus determines whether the customer is present in the checkout waiting area.

If the customer is present in the checkout waiting area, that is, if the customer is waiting for checkout, the determination unit 313 determines the type of sales data processing device 10 or the checkout spot to be recommended for the customer, from among the plurality of different types of sales data processing devices 10 based on the extracted factor related to the checkout time. The type of the sales data processing device 10 to be determined is, for example, one of the full-self-service type, the semi-self-service type, and the staffed checkout device type, as shown in the type information illustrated in FIG. 3. Also, two checkout device forms may be determined, depending on the number of people waiting for checkout at each of the plurality of sales data processing devices 10.

The semi-self-service type is a type of the sales data processing device 10 with which the store staff performs a part of operations related to the checkout of a merchandise item and may be referred to as a first type. The full-self-service type is a type of the sales data processing device 10 with which the customer performs the operations related to the checkout of a merchandise item and may be referred to as a second type. The staffed checkout device type (also referred to as the store staff checkout device) is a type of the sales data processing device 10 with which the store staff performs all the operations related to the checkout of a merchandise item and may be referred to as a third type.

For example, the determination unit 313 determines the recommended type of checkout device, using the extracted merchandise data (i.e., the quantity of the merchandise item and the attribute of the merchandise item) and/or the number of people waiting for checkout. Specifically, the determination unit 313 compares the quantity of the checkout target merchandise item held by the customer waiting for the checkout, with a predetermined threshold. If the quantity of the checkout target merchandise item held by the customer waiting for the checkout is less than the predetermined threshold, the determination unit 313 determines the second type, with which the customer performs the operations related to the checkout of the merchandise item, as the recommended type of checkout device. That is, if the quantity of the merchandise item is less than the predetermined threshold, the determination unit 313 determines the full-self-service checkout device, that is, the sales data processing device in the second type, as the checkout device recommended to the customer.

If the quantity of the checkout target merchandise item held by the customer waiting for the checkout is equal to or more than the predetermined threshold, the determination unit 313 determines the first type, with which the store staff performs a part of the operations related to the checkout of the merchandise item, as the recommended type of checkout device. That is, if the quantity of the merchandise item is equal to or more than the predetermined threshold, the determination unit 313 determines the semi-self-service checkout device as the checkout device recommended to the customer.

The determination unit 313 compares the quantity of the merchandise item for which a field included in the attribute needs to be selected at the time of checkout (i.e., the merchandise item involving complexity at the checkout), with a predetermined set value. If the quantity of the merchandise item involving complexity at the checkout is equal to or more than the predetermined set value, the determination unit 313 determines the first type (i.e., the semi-self-service type) and/or the third type (i.e., the staffed type) as the type of checkout device recommended to the customer.

The notification unit 314 notifies the customer of the type of checkout device determined by the determination unit 313. For example, the notification unit 314 collates the determined type of checkout device with the checkout device management table T3 and specifies the checkout device number corresponding to the determined type of checkout device. The notification unit 314 notifies the customer of the determined type of checkout device along with the checkout device number via the display terminal 25. The notification unit 314 may notify the customer of the determined type of checkout device along with the checkout device number by voice.

If the determined type of checkout device is the semi-self-service type or the staffed checkout device type, the notification unit 314 may collate the years of employment of the store staff serving at the sales data processing device corresponding to the semi-self-service type or the staffed checkout device type, with the store staff management table T4, and thus may specify the sales data processing device. Then, the notification unit 314 may notify the customer of the sales data processing device for which the waiting line is shorter and at which store staff employed for many years is serving. The notification unit 314 may notify the customer waiting for the checkout, of a guidance to the sales data processing device corresponding to the checkout device number, in addition to notifying the customer waiting for the checkout, of the recommended type of the sales data processing device 10.

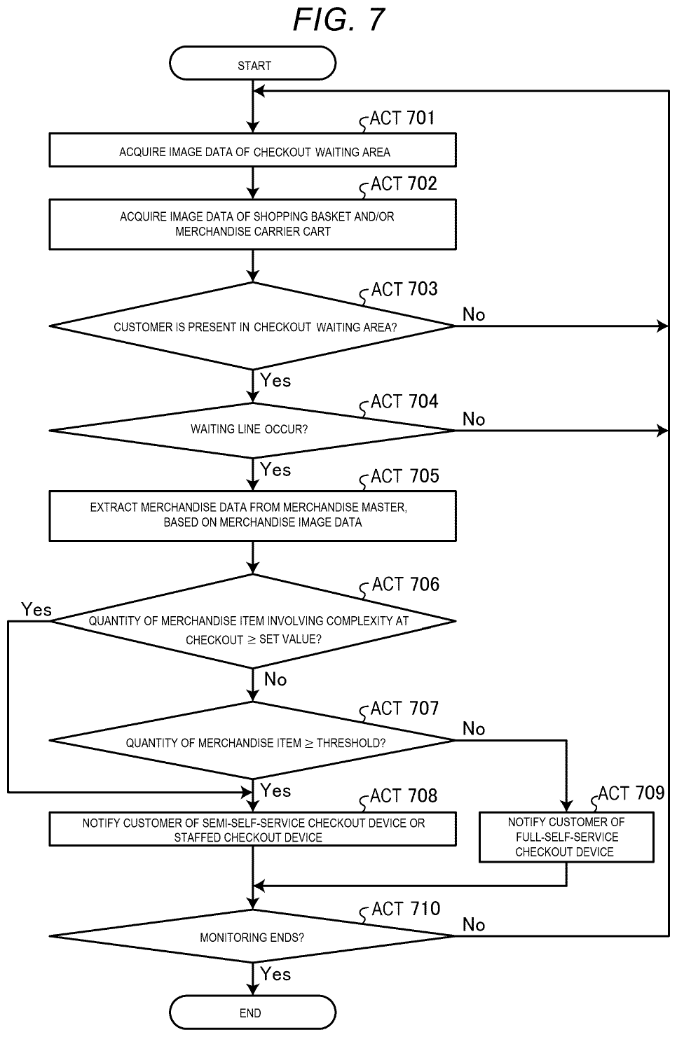

Processing to support purchase executed by the purchase support device 30 and the purchase support system 1 (hereinafter referred to as purchase support processing) will now be described. FIG. 7 is a flowchart showing the purchase support processing. The purchase support processing starts if a customer is recognized in the merchandise image data or the area image data in response to the entry of the customer into the store, that is, based on the image pickup of the image of the customer at the time of entry into the store by the first camera 21 or the second camera 22 and the customer ID is registered in the stored merchandise management table T2.

### Purchase Support Processing

In ACT 701, based on an image of the checkout waiting area captured by the first camera 21, image data is generated. The acquisition unit 311 acquires the image data of the checkout waiting area from the first camera 21. The acquisition unit 311 stores the image data of the checkout waiting area in the memory unit 38. The extraction unit 312 extracts the number of people waiting for the processing at the sales data processing device 10 as the factor related to the checkout time of the merchandise item, from the image data of the checkout waiting area.

In ACT 702, based on an image of the shopping basket and/or the shopping cart captured by the second camera 22, merchandise image data is generated. The acquisition unit 311 acquires the merchandise image data from the second camera 22. The acquisition unit 311 stores the merchandise image data generated by the second camera 22 in the memory unit 38. The extraction unit 312 suitably updates the various fields in the stored merchandise management table T2, based on the merchandise image data generated by the second camera 22.

In ACT 703, the determination unit 313 determines whether the customer is located in the checkout waiting area, based on the image data of the checkout waiting area. That is, if the customer is present in the checkout waiting area for a predetermined time (Yes in ACT 703), the processing of ACT 704 is executed. If the customer is not present in the checkout waiting area for the predetermined time (No in ACT 703), the processing of ACT 701 is executed. The predetermined time is set in advance to be, for example, 30 seconds, one minute, or the like, and is stored in the memory unit 38.

In ACT 704, if a waiting line occurs in the checkout waiting area (Yes in ACT 704), the processing of ACT 705 is executed. If a waiting line does not occur in the checkout waiting area (No in ACT 704), the processing of ACT 701 is executed.

In ACT 705, the extraction unit 312 extracts the merchandise data (i.e., the quantity of the merchandise item and the attribute of the merchandise item, whether the selection need information is included, and the like) from the merchandise master T1, based on the image data of the shopping basket and/or the shopping cart. For example, the extraction unit 312 extracts the merchandise feature data, based on the merchandise image data. Subsequently, the extraction unit 312 collates the extracted merchandise feature data with the merchandise master T1 and extracts the merchandise data of the merchandise item included in the shopping basket and/or the shopping cart, from the merchandise master T1. In addition, the extraction unit 312 extracts the quantity of the merchandise item correlated with the selection need information from the merchandise master T1.

In ACT 706, the determination unit 313 compares the quantity of the merchandise item correlated with the selection need information (i.e., the merchandise item involving complexity at the checkout) with a predetermined set value. If the quantity of the merchandise item involving complexity at the checkout is equal to or more than the set value (Yes in ACT 706), the processing of ACT 708 is executed. If the quantity of the merchandise item involving complexity at the checkout is less than the set value (No in ACY 706), the processing of ACT 707 is executed.

In ACT 707, the determination unit 313 compares the volume of the checkout target merchandise item held by the customer waiting for the checkout, with a predetermined threshold. For example, if the volume of the merchandise item stored in the shopping basket and/or the shopping cart is equal to or more than the predetermined threshold (Yes in ACT 707), the processing of ACT 708 is executed. If the volume of the merchandise item stored in the shopping basket and/or the shopping cart is less than the predetermined threshold (No in ACT 707), the processing of ACT 709 is executed.

In ACT 708, the determination unit 313 determines the first type (i.e., the semi-self-service checkout device) and/or the third type (i.e., the staffed checkout device) as the type of checkout device recommended to the customer. The notification unit 314 collates the determined type of checkout device with the checkout device management table T3 and specifies the checkout device number corresponding to the determined type of checkout device. At this time, the notification unit 314 may collate the years of employment of the store staff serving at the checkout device of the specified checkout device number, with the store staff management table T4, and thus may specify the checkout device. Subsequently, the notification unit 314 notifies the customer of the checkout device number of the semi-self-service checkout device and/or the checkout device number of the staffed checkout device for which the waiting line is shorter and at which store staff employed for longer years is serving, via the display terminal 25 or the like.

In ACT 709, the determination unit 313 determines the full-self-service checkout device, that is, the sales data processing device in the second type, as the checkout device recommended to the customer. The notification unit 314 collates the second type with the checkout device management table T3 and specifies the checkout device number corresponding to the second type. The notification unit 314 notifies the customer of the checkout device number of the full-self-service checkout device via the display terminal 25 or the like. At this time, the notification unit 314 may notify the customer of a guidance for the customer to this checkout device number.

In ACT 710, if the monitoring for the guidance to the checkout device ends (Yes in ACT 710), the purchase support processing ends. If the monitoring for the guidance to the checkout device does not end (No in ACT 710), the processing of ACT 701 is executed. The end of the monitoring is, for example, the detection of the closing time of the store, or the like.

As described above, the purchase support device 30 and the purchase support system 1 acquire image data of an image of a shopping basket and/or a shopping cart held by a customer moving inside a store, determine, from the image data, a factor related to a checkout time of a merchandise item stored in the shopping basket and/or the shopping cart held or used by the customer, determine a type recommended as a checkout spot for the customer, from among a plurality of different types of sales data processing devices 10 that perform processing related to checkout of a merchandise item, based on the factor related to the checkout time, and notify the customer of the determined type.

For example, the purchase support device 30 and the purchase support system 1 extract merchandise data including a quantity of the merchandise item and an attribute of the merchandise item stored in the shopping basket and/or the shopping cart, as the factor related to the checkout time, from merchandise image data, and determine the recommended type of checkout device, using the merchandise data. Also, the purchase support device 30 and the purchase support system 1 further acquire image data of an image of the checkout waiting area in the store where the plurality of different types of sales data processing devices 10 are placed, extract a number of people waiting for processing at the sales data processing device 10 as the factor related to the checkout time, from the image data, and determine the recommended type of checkout device, using the number of people.

Based on the above, the purchase support device 30 and the purchase support system 1 can acquire information such as the quantity and attribute of a merchandise item to be purchased by a customer in a checkout waiting line by utilizing a monitoring camera or the like installed in the store, in determining what type of checkout device should be used to complete shopping more quickly, and thus can notify the customer of a recommended type of checkout device and a guidance to the checkout device. Therefore, the purchase support device 30 and the purchase support system 1 can reduce the burden on the customer when selecting a type of checkout device in the checkout of a merchandise item in a store where a plurality of different types of checkout devices such as a semi-self-service checkout device and a full-self-service checkout device are installed.

Also, the purchase support device 30 and the purchase support system 1 determine a type of a full-self-service checkout device with which a customer performs operations related to checkout, as the recommended type of checkout device, if the quantity of the merchandise item stored in the shopping basket and/or the shopping cart is less than a predetermined threshold, and determine a type of a semi-self-service checkout device with which store staff performs a part of the operations related to checkout, as the recommended type of checkout device, if the quantity of the merchandise item stored in the shopping basket and/or the shopping cart is equal to or more than the predetermined threshold. Thus, the purchase support device 30 and the purchase support system 1 can determine an optimal type of checkout device in response to the quantity of the checkout target merchandise item.

Also, the purchase support device 30 and the purchase support system 1, from the merchandise image data, the quantity of a merchandise item for which at least one field needs to be selected at the time of checkout, of the merchandise items stored in the shopping basket and/or the shopping cart, and determine a type of a semi-self-service checkout device with which store staff performs a part of operations related to the checkout of a merchandise item and/or a type of a staffed checkout device with which store staff performs all the operations related to the checkout of a merchandise item, as the recommended type of checkout device, if the quantity of the merchandise item for which the foregoing field needs to be selected is equal to or more than a predetermined set value. Thus, for example, if the quantity of a merchandise item for which the size, category, weight and the like need to be selected at the time of checkout, such as a vegetable from among fresh food, is equal to or more than the set value, a type of checkout device that leads to a reduction in the checkout time is determined in accordance with the degree of congestion of the waiting line and/or the years of employment (or checkout skill or the like) of the store staff performing the checkout, and the customer can be notified of the determined type of checkout device.

Based on the above, the purchase support device 30 and the purchase support system 1 can notify the customer of a suitable type of checkout device in accordance with the checkout target merchandise item, from among a plurality of different types of checkout devices that perform processing related to the checkout of a merchandise item. Therefore, the purchase support device 30 and the purchase support system 1 reduce crowds in the waiting for checkout, thus can relax the stress of the customer in the waiting for checkout, and can reduce customer complaints. In addition, the purchase support device 30 and the purchase support system 1 can reduce the customer's shopping time, specifically, the total checkout time for the checkout of the merchandise item and therefore can improve the turnover in terms of shopping by customers in the store. Also, the purchase support device 30 automatically provides a guidance about a type of checkout device recommended for checkout and thus can reduce the burden on the store.

### Modification Example

In this modification example, if a display (or a user terminal) is installed on each shopping cart, the user terminal is notified of a type of checkout device recommended for checkout. In this case, for example, an identifier that can identify each shopping cart and each user terminal is set on each shopping cart and/or each user terminal. The identifier is equivalent to, for example, a barcode, a two-dimensional code or the like.

The first camera 21 and/or the second camera 22 capture an image of the identifier. The acquisition unit 311 acquires the identifier from the first camera 21 and/or the second camera 22. Based on the identifier, the extraction unit 312 specifies the shopping cart and/or the user terminal used or operated by the customer. At this time, the extraction unit 312 registers, for example, the cart ID corresponding to the identifier in such a way as to correspond to the customer ID in the stored merchandise management table T2. Also, as long as the correspondence between the cart ID and the customer ID is provided, the identifier need not be registered in the stored merchandise management table T2. Since the correspondence between the shopping cart and/or the user terminal used or operated by the customer and the customer ID is established by the above processing, the notification unit 314 notifies the customer of the type of checkout device determined by the determination unit 313, via the user terminal.

In this modification example, before the execution of the purchase support processing, the registration of the cart ID corresponding to the shopping cart and/or the user terminal in the stored merchandise management table T2 is performed or the correspondence between the customer ID and the cart ID is established, at the time of registration of the customer ID in the stored merchandise management table T2. The processing content of the purchase support processing is similar to the processing content in the above-described embodiment and therefore will not be described further. The purchase support device 30 and the purchase support system 1 according to this modification example notify the user terminal on the shopping cart operated by the customer, of the type of checkout device recommended at the time of checkout. Thus, the purchase support device 30 and the purchase support system 1 according to this modification example can improve the visibility of the recommended type of checkout device.

If the technical idea according to the embodiments is implemented in the type of a purchase support program, the purchase support program causes a computer to implement: acquiring image data of an image of a shopping basket and/or a shopping cart held or used by a customer moving inside a store; extracting, from the image data, a factor related to a checkout time of a merchandise item stored in the shopping basket and/or the shopping cart held by the customer; determining a type recommended as a checkout spot for the customer, from among a plurality of different types of sales data processing devices that perform processing related to checkout of a merchandise item, based on the factor related to the checkout time; and notifying the customer of the determined form.

The purchase support processing can be implemented, for example, by installing the purchase support program in a computer such as various server devices installed in the store and loading the purchase support program on a memory. In this case, the program that can cause the computer to execute the purchase support processing can be distributed in the type of being stored in a non-transitory computer readable storage medium such as a magnetic disk (hard disk or the like), an optical disk (CD-ROM, DVD or the like), or a semiconductor memory. The distribution of the purchase support program is not limited to the use of the medium and may be realized, for example, by using a telecommunication function such as downloading via the internet. The processing procedures of the purchase support program are in conformity with the purchase support processing according to the embodiment. The effects of the purchase support program are similar to those of the embodiment. Therefore, the processing procedures and effects of the purchase support program will not be described further.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the type of the embodiments described herein may be made without departing from the spirit of the disclosure. The accompanying claims and their equivalents are intended to cover such forms or modifications as would fall within the scope and spirit of the disclosure.

What is claimed is:

1. A store monitoring device comprising:
a communication interface connectable to one or more cameras installed in a store;
a memory that stores a program and first information indicating a plurality of checkout devices installed in the store, the checkout devices including one or more self-service checkout devices and one or more staffed checkout devices; and
a processor configured to execute the program to:
acquire a plurality of images from the cameras and identify from the images:
one or more first images of customers and containers or carts used by the customers, and
one or more second images of a checkout waiting area in which customers can form a line for checkout,
identify a first customer and one or more first items to be purchased by the first customer based on the first images,
determine whether the first customer is in the checkout waiting area based on the second images,
upon determining that the first customer is in the checkout waiting area, determine whether a line is formed in the checkout waiting area based on the second images,
upon determining that a line is formed, determine a first quantity of the first items,
when the first quantity is greater than or equal to a threshold, generate and output first guidance information for guiding the first customer to one of the staffed checkout devices, and
when the first quantity is less than the threshold, generate and output second guidance information for guiding the first customer to one of the self-service checkout devices.

2. The store monitoring device according to claim 1, wherein
the processor executes the program to:
determine an attribute of each of the first items,
determine a second quantity of one or more of the first items having a predetermined attribute, and
when the second quantity is greater than or equal to a preset value, generate and output the first guidance information regardless of the first quantity.

3. The store monitoring device according to claim 2, wherein
the predetermined attribute indicates that the corresponding item needs an input of additional information during checkout.

4. The store monitoring device according to claim 3, wherein
the additional information is a size, a category, or a weight of the item.

5. The store monitoring device according to claim 1, wherein
the processor executes the program to count a number of the customers waiting in the checkout waiting area based on the second images to determine whether the line is formed.

6. The store monitoring device according to claim 1, wherein
the staffed checkout devices include a first checkout device at which a store staff member performs both registration and payment processing and a second checkout device at which a store staff member performs registration processing and a customer performs payment processing.

7. The store monitoring device according to claim 1, wherein
the processor executes the program to:
determine a number of customers forming a line for each of the staffed checkout devices based on the second images, and
select one of the staffed checkout devices for which the lowest number of customers form a line, and
the first guidance information indicates the selected one of the staffed checkout devices.

8. The store monitoring device according to claim 1, wherein
the first information associates each of the staffed checkout devices with a length of employment of a store staff member who operates the staffed checkout device,
the processor executes the program to select one of the staffed checkout devices operated by a store staff member having the greatest length of employment, and
the first guidance information indicates the selected one of the staffed checkout devices.

9. The store monitoring device according to claim 1, wherein
the processor executes the program to output the first guidance information to a terminal attached to the cart used by the first customer.

10. The store monitoring device according to claim 1, wherein
the processor executes the program to output the first guidance information to a terminal installed in the checkout waiting area.

11. A point-of-sale (POS) system comprising:
a plurality of checkout devices installed in a store and including one or more self-service checkout devices and one or more staffed checkout devices;
one or more cameras installed in the store; and
a store monitoring device comprising:
a memory that stores a program and first information indicating the plurality of checkout devices, and
a processor configured to execute the program to:
acquire a plurality of images from the cameras and identify from the images:
one or more first images of customers and containers or carts used by the customers, and
one or more second images of a checkout waiting area in which customers can form a line for checkout,
identify a first customer and one or more first items to be purchased by the first customer based on the first images,
determine whether the first customer is in the checkout waiting area based on the second images,
upon determining that the first customer is in the checkout waiting area, determine whether a line is formed in the checkout waiting area based on the second images,
upon determining that a line is formed, determine a first quantity of the first items,
when the first quantity is greater than or equal to a threshold, generate and output first guidance information for guiding the first customer to one of the staffed checkout devices, and
when the first quantity is less than the threshold, generate and output second guidance information for guiding the first customer to one of the self-service checkout devices.

12. The POS system according to claim 11, wherein
the processor executes the program to:
determine an attribute of each of the first items,
determine a second quantity of one or more of the first items having a predetermined attribute, and
when the second quantity is greater than or equal to a preset value, generate and output the first guidance information regardless of the first quantity.

13. The POS system according to claim 12, wherein
the predetermined attribute indicates that the corresponding item needs an input of additional information during checkout.

14. The POS system according to claim 13, wherein
the additional information is a size, a category, or a weight of the item.

15. The POS system according to claim 11, wherein
the processor executes the program to count a number of the customers waiting in the checkout waiting area based on the second images to determine whether the line is formed.

16. The POS system according to claim 11, wherein
the staffed checkout devices include a first checkout device at which a store staff member performs both registration and payment processing and a second checkout device at which a store staff member performs registration processing and a customer performs payment processing.

17. The POS system according to claim 11, wherein
the processor executes the program to:
determine a number of customers forming a line for each of the staffed checkout devices based on the second images, and
select one of the staffed checkout devices for which the lowest number of customers form a line, and
the first guidance information indicates the selected one of the staffed checkout devices.

18. The POS system according to claim 11, wherein
the first information associates each of the staffed checkout devices with a length of employment of a store staff member who operates the staffed checkout device,
the processor executes the program to select one of the staffed checkout devices operated by a store staff member having the greatest length of employment, and
the first guidance information indicates the selected one of the staffed checkout devices.

19. The POS system according to claim 11, wherein
the processor executes the program to output the first guidance information to a terminal attached to the cart used by the first customer.

20. A non-transitory computer readable storage medium that causes a computer to execute a method comprising:
storing in a memory a program and first information indicating a plurality of checkout devices installed in a store, the checkout devices including one or more self-service checkout devices and one or more staffed checkout devices;
acquiring a plurality of images from one or more cameras installed in the store and identifying from the images:
one or more first images of customers and containers or carts used by the customers, and
one or more second images of a checkout waiting area in which customers can form a line for checkout;
identifying a first customer and one or more first items to be purchased by the first customer based on the first images;
determining whether the first customer is in the checkout waiting area based on the second images;
upon determining that the first customer is in the checkout waiting area, determining whether a line is formed in the checkout waiting area based on the second images;
upon determining that a line is formed, determining a first quantity of the first items;
when the first quantity is greater than or equal to a threshold, generating and outputting first guidance information for guiding the first customer to one of the staffed checkout devices; and
when the first quantity is less than the threshold, generating and outputting second guidance information for guiding the first customer to one of the self-service checkout devices.
